(19) United States
(12) Patent Application Publication
(10) Pub. No.: US 2008/0126105 A1
(43) Pub. Date: May 29, 2008

(54) Kit for the creation of custom postage and a method for using same

(76) Inventor: George A. Castineiras, Farmington, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/490,726

(22) Filed: Jul. 21, 2006

(51) Int. Cl. G06Q 99/00

(52) U.S. Cl. 705/1

(57) ABSTRACT

In a kit for the creation of custom postage at least one artform is provided and includes an a real portion upon which a user can create original artwork. An order form is also provided for ordering a quantity of custom postage, as is at least one shipping receptacle for forwarding one or more of the artforms having the original artwork thereon, and a completed one of the order forms, to a facility for processing custom postage orders. Instructions are provided for using the kit including instructions directed to creating the original artwork, as well as for completing the order form. Materials for creating the original artwork are also included in the kit.

### CROSS REFERENCE TO RELATED APPLICATIONS

This application is related to U.S. patent application Ser. No. 11/168,651, filed on Jun. 27, 2005 and U.S. patent application Ser. No. 11/396,895 filed Apr. 3, 2006, the contents of which are incorporated herein by reference in their entirety.

### FIELD OF THE INVENTION

present invention is generally directed to the creation of custom postage and is more particularly directed to a kit having the materials therein necessary for creating custom artwork to be used on custom postage and for ordering said postage.

### BACKGROUND OF THE INVENTION

Customization of items ranging from stationary to clothing to make these items unique to an individual or group has been popular for quite some time. With the advent of digital technology, such customization has become much more accessible and economical. For example, scanners allow images to be “scanned” into a computer where they can be digitally stored. These images, including photographs and other types of graphics, can be printed onto T-shirts, coffee cups, buttons and various other items. Accordingly, graphics, designs, and other original artwork created by hand, through the intervention of digital technology, can now be readily digitized and printed in various forms onto a myriad of different media.

Based on the foregoing, it is the general object of the present invention to provide an expedient means whereby original artwork can be converted into custom postage.

### SUMMARY OF THE INVENTION

The present invention is directed in one aspect to a kit for the creation of custom postage. The kit is supplied in various forms, the contents of which can be varied and adapted to appeal and be easily used by different age groups. Each kit will include at least one and preferably several artforms. Each artform will define an a real portion onto which a user can create original artwork. In general, the user will create the original artwork by drawing it directly onto the artform. However, the present invention is not limited in this regard. The term “original artwork” as used herein should be broadly construed to include such things as, but not be limited to, photographs, graphics created using stickers, clippings, colored paper or the like, drawings, or combinations thereof. An order form is also provided in the kit and can be a separate form, or be incorporated directly into the artform. At least one shipping receptacle, preferably, but not limited to, a self-addressed prepaid envelope is provided in the kit so that upon generating the custom artwork on the artform, and completing the order form, these items can be placed in the envelope and forwarded to a facility that will facilitate processing the order and the generation of the custom postage. The kit will also include materials for use in generating the custom artwork.

The order form can be a separate document included in the kit, or it can be part of the artform. If part of the artform, the order form can constitute a second a real portion on the form or it can be embodied on a reverse side of the form.

The materials for use in generating custom artwork can include such things as, but art not limited to, crayons, colored pencils, pens, markers, stickers, stencils, scissors, charcoals, paints, paintbrushes, etc. The materials provided in the kit can vary based on the age group to which the particular kit is directed.

In one embodiment of the present invention, the kit is adapted to be used with infants. In this embodiment, the above described materials to be supplied with the kit would include an inkpad sized to allow the infant's hand or foot to fit onto the inkpad. The infant's foot or hand would be placed on the inkpad and thereby covered with ink. The infant's inked foot or hand would then be placed on the artform, thereby transferring a handprint or footprint to the artform. Accordingly, custom postage could then be generated with the infant's handprint or footprint thereon. These kits can also be gender specific. For example, if the kit was for a boy, the inkpad could be blue. If the kit was for a girl, the inkpad could be pink.

The kit can also include instructional DVDs or videos as well as instructional materials regarding the use of custom postage as a fundraising vehicle. Furthermore, the materials supplied with the kit can include jump starts. Jump starts can include such things as backgrounds to be used for artwork, stickers, stencils, colored paper, and other age appropriate or themed items that can be used in creating the original artwork. In addition, the kit can include directions to a website where clip art specific to different themes, events, and/or age groups can be accessed and printed.

The present invention also contemplates the ability to download additional artforms over the internet. A user would access a specific website where the downloadable artforms can be found and would then be able to download the forms. The ability to access the forms can be password protected with the password being provided in, and unique to a particular kit or kit type. For example, if the kit is structured for use by young artists, the password may only allow access to areas devoted to that particular demographic. In addition, the password may also allow the user to access a program that allows the user to create the original artwork online and electronically. The program can allow the user to electronically draw on an electronic version of the artform viewed on a user's computer screen. In addition to or as a substitute for drawing, a user may access the program and use various different backgrounds or clip art to create their artwork, the backgrounds and clip art being made available to the user by the program.

Rather than the user accessing a program via the internet as described above, the program can be provided on a CD included in the kit or the kit can include a password and instructions for downloading the program onto a user's computer so that it is resident thereon.

The present invention also contemplates a user accessing, via the internet and a website, an electronic image of artwork they submitted for conversion into custom postage for further modification and editing. A user can access their artwork via a website and entry of a security code. The security code can be provided in the kit or an access code forwarded to the user once the artwork is received. Once accessed, a user can be given several options for editing their artwork. These options can include such things as, but are not limited to, changing colors, adding text or incorporating backgrounds or clip art into the artwork. In addition, a user can be given the option of changing a border or text portion of the custom postage to a color that is complementary to or identical to a color in the artwork. Methods for accomplishing this are disclosed and claimed in U.S. patent application Ser. No. 11/098,807, the disclosure of which is incorporated in its entirety herein by reference.

To customize these colors, a user accesses a web site where an image of the custom postage can be displayed and associated with a program operable to accomplish the above-referenced color customization. Once the image of the custom postage is displayed, a user selects any color on the image by pointing to it and “clicking” using a mouse or other pointing device. Once selected, that color is reproduced in the postage areas of the custom postage. In addition, the program can also generate a palette of selectable colors that are complementary to the color selected with appropriate and necessary level of contrast. Once the palette is generated, one or more of the colors thereon can be selected to customize the textual portion of the postage area.

### DETAILED DESCRIPTION OF THE PREFERRED EMBODIMENTS

The present invention is directed to kits for the creation of custom postage. These kits would be purchased through retail outlets or online. As will be explained in detail below, the kits can be customized for particular genders and age groups. Each kit will contain at least one, and preferably several artforms upon which a user can create original artwork. Each artform will have an a real portion thereon into which the artwork should be positioned. As will be explained in greater detail below, an order form is provided for ordering a quantity of custom postage. The order form can be combined with the artform and encompass a separate a real portion of the form, or it can occupy a reverse side of the artform.

At least one shipping receptacle is provided for forwarding one or more of the artforms having the original artwork thereon, and a completed one of the order forms, to a facility for processing the custom postage orders. Preferably, the shipping receptacle is a self-addressed prepaid envelope. However, the present invention is not limited in this regard as a box or other acceptable container can be employed without departing from the broader aspects of the present invention. Moreover, the receptacle may not be postage prepaid.

Instructions for using the kit, including instructions directed to creating the original artwork and for completing the order form, are also provided in the kit. These instructions can be provided in different media or combinations of media. For example, the instructions could be of the traditional paper type, on CD, DVD or video, or combinations thereof. Furthermore, the instructions can also include an explanation of how custom postage can be used as part of a fund raising event.

In addition to the foregoing, materials for creating the above-described original artwork are also provided. Depending on the type of kit, these materials can vary. For example, in one embodiment of the present invention, the kit is directed to newborns and infants whereby custom postage incorporating the child's handprint and/or footprint can be created. In such a kit, an inkpad of a size appropriate to accommodate the child's hand and foot is provided as part of the supplied materials. The child's hand and/or foot can be applied to the inkpad, transferring ink thereto, and then the hand or foot is pressed against the appropriate a real portion of the artform to create the handprint or foot print. The kit for this embodiment of the present invention can also be gender specific. For example, a blue inkpad could be supplied for a kit directed to males and a pink inkpad could be supplied to a kit directed to females. Alternatively, the newborn kit can be supplied with both a pink and a blue inkpad or a single inkpad can be bifurcated with a blue portion and a pink portion. This will allow for a single kit to be gender neutral and accommodate either a male or female newborn. However, the present invention is not limited in this regard as other materials more closely associated to one gender rather than the other could be provided in gender specific kits.

Depending on the age of the user of the kit, different types of materials may be supplied. For instance, kits directed to younger artists may include, but are not limited to, such materials as crayons, colored pencils, markers, water paints and the like. In addition, these kits may also include predrawn designs on the artforms that the artists can simply color in. Kits directed to older or more advanced artists can include, but are not limited to, oil paints and paint brushes, pastels and charcoals, etc. In addition, the materials can also include such things as stickers, tape, stamps and stamp pads, colored paper, tape, glue, rulers and scissors.

In addition to age and gender specific kits, kits can also be directed to specific themes and events such as, but not limited to, holidays, birthdays, weddings, anniversaries, sports, animals, cars etc.

While the kits have been thus far described as being directed to the generation of custom postage, the present invention is not limited in this regard. In addition to custom postage, the kits can also include forms for ordering such things as keychains, notecards, mugs, T-shirts, and other items that would bear an image of the original artwork thereon. As will be explained in detail below, once an order is forwarded to the processing facility, the order will be fulfilled, and the items embodying the order subsequently shipped to the purchaser.

To fulfill an order, the artform having the original artwork thereon as well as a completed order form is positioned in the provided envelope along with payment instructions and forwarded to the processing facility. With respect to payment instructions, the kit may have a certain amount of custom postage included in the purchase price of the kit. However, the purchase price can also not include the cost for any custom postage. Regardless, the order form of the present invention includes an area where payment information, such as credit card information, can be specified. In addition, a purchaser will specify the amount of custom postage desired as well as any other items they may desire to order.

Upon receiving the completed order forms and artforms, the processing facility processes the payments pursuant to the information provided on the order forms. Payment can be made, or authorized to be made by any number of different methods. For example, payments can be made by credit card, or by using an internet based payment service, such as, for example, PayPal®. In addition, it is contemplated that payment can be made via check, cash or money order. In any instance where the processing facility is unable to process payment, the entity making payment will be contacted for resolution.

Once payment has been processed, the completed artforms are scanned into a database. Preferably, a high speed scanner is employed to accomplish this task. The scanned information is parsed and appropriately entered into the database. This information includes, but may not be limited to, the image on the artform, any barcode information associated with or on the artform or order, and initial order information. In addition, some or all of the information may be manually entered. Manual entry may be accomplished twice for each piece of data. When this is done, two different people each enter the same information. If a discrepancy is discovered, the information is checked and the discrepancy is resolved. Checking information obtained from the artforms may also be accomplished electronically. Once the accuracy of the scanned or otherwise input information, including the artwork is verified, a unique identification code can be generated for and associated with the information pertaining to each artform submission.

The unique participant identification code may be used to create a unique URL and code that a purchaser may access to order or reorder custom postage or other items pertaining to the artwork associated with the particular artwork to which the URL pertains.

The artform provided with the kit can include a barcode thereon. The barcode can serve a number of purposes. It can, once scanned, identify the kit type the artform was provided in. The image on the artform can be associated with the barcode at the processing facility to provide a means of identifying and archiving the particular image.

Prior to printing the custom postage, a final check may be performed. Any artwork that is inappropriate or for some other reason is deficient such that printing is not advisable, will be returned and a refund for any moneys paid will be processed. Once the final check is performed, any approved artwork will then be printed as custom postage. The custom postage will be in stamp-like form, adhesively backed, and will be provided on sheets with a predetermined number of pieces of custom postage per sheet. Once printed, the custom postage is mailed directly to the purchasers.

The present invention also contemplates purchasers having the ability to further customize the custom postage they purchase by being able to customize the colors of the printing corresponding to postage amount and any other printing on the postage, as well as borders around the postage. Methods for accomplishing this are disclosed and claimed in U.S. patent application Ser. No. 11/098,807, the disclosure of which is incorporated in its entirety herein by reference. To customize these colors, a user accesses a website where an image of the custom postage can be displayed and associated with a program operable to accomplish the above-referenced color customization. Once the image of the custom postage is displayed, a user selects any color on the image by pointing to it and “clicking” using a mouse or other pointing device. Once selected, that color is reproduced in the postage areas of the custom postage. In addition, the program can also generate a palette of selectable colors that are complementary to the color selected with appropriate and necessary level of contrast. Once the palette is generated, one or more of the colors thereon can be selected to customize the textual portion of the postage area.

Purchasers can also be given the option of further personalizing the custom postage by specifying a label or title that will be input by the facility processing the custom postage so that the label or title appears on the custom postage image. The title or label can be limited to a maximum number of characters. In addition, a purchaser may have the option of choosing font, font size, color, and the styles by which the title or label will appear on the custom postage. For example, a purchaser may want to have text appear in a text balloon.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A kit for the creation of custom postage comprising:
at least one artform having an a real portion upon which a user can create original artwork;
an order form for ordering a quantity of custom postage;
at least one shipping receptacle for forwarding one or more of said artforms having said original artwork thereon, and a completed one of said order forms, to a facility for processing custom postage orders;
instructions for using said kit including instructions directed to creating said original artwork; for completing said order form; and
materials for creating said original artwork.

2. A kit as defined by claim 1 wherein said order form is defined as a second a real portion on said artform.

3. A kit as defined by claim 1 wherein said materials for creating said original artwork are different dependent upon the age group to which said kit is directed.

4. A kit as defined by claim 1 wherein said materials include creative jump starts relevant to the age group to which said kit is directed.

5. A kit as defined by claim 1 further comprising promotional materials explaining how the creation of custom postage from original artwork can be used as a fund raiser.

6. A kit as defined by claim 5 wherein said promotional materials include one of a video or DVD.

7. A kit as defined by claim 1 wherein said order form includes instructions for ordering promotional items incorporating said original artwork.

8. A kit as defined by claim 7 wherein said promotional items include at least one of keychains and note cards.

9. A kit as defined by claim 1 wherein said shipping receptacle is a prepaid envelope.

10. A kit as defined by claim 1 wherein said materials include at least one inkpad of a size sufficient to allow for an infant's hand or foot to be inked so that a handprint or footprint can be transferred onto said artform.

11. A kit as defined by claim 1 wherein said materials include paints and at least one paint brush.

12. A kit as defined by claim 10 wherein said kit is specific to one of a boy and girl with the inkpad being blue if the kit is for a boy and pink if the kit is for a girl.

13. A kit as defined by claim 1 further comprising instructional materials explaining the manner in which the creation of custom postage could be used as a fundraising activity.

14. A method for creating custom postage incorporating original artwork comprising:
obtaining a kit including at least one artform having an a real portion upon which a user can create original artwork; an order form for ordering a quantity of custom postage; at least one shipping receptacle for forwarding one or more of said artforms having said original artwork thereon, and a completed one of said order forms, to a facility for processing custom postage orders; instructions for using said kit including instructions directed to creating said original artwork; for completing said order form; and materials for creating said original artwork;
using said materials provided in said kit to produce said original artwork on said a real portion defined by said order form;
completing said order form thereby indicating an amount of custom postage desired and specifying a method of payment;
placing said completed order form and said artform bearing said original artwork into said shipping receptacle;
forwarding said shipping receptacle via one of mail and courier service to said facility for processing said custom postage orders; and
fulfilling said custom postage order by processing said payment information, generating said custom postage and shipping said custom postage order to a purchaser.

15. A kit as defined by claim 10 wherein said inkpad is bifurcated with one portion defining a first ink color and another portion defining a second ink color.
